(19) United States
(12) Patent Application Publication
(10) Pub. No.: US 2005/0063247 A1
(43) Pub. Date: Mar. 24, 2005

(54) Biobag undulating mixing system

(76) Inventor: Richard James Krause, Perkasie, PA (US)

Correspondence Address: RICHARD J. KRAUSE, 16 SMITH SCHOOL ROAD, PERKASIE, PA, 18944, US

(21) Appl. No.: 10/945,345

(22) Filed: Sep. 20, 2004

Related U.S. Application Data
(60) Provisional application No. 60/504,622, filed on Sep. 22, 2003.

(51) Int. Cl. B01F 11/00

(52) U.S. Cl. 366/111; 366/208; 366/218

(57) ABSTRACT

A multiple single-use bag mixing system utilizing lifting one end of the bag at a harmonic frequency determined by the viscosity of the fluids and bag dimensions. The bags are positioned on stationary racks with UV or white light source positioned over each bag were required. The degree of energy efficient gentile mixing is determine by a variable speed drive moving the ends of all the bags simultaneously on the racks.

### CROSS-REFERENCE TO RELATED APPLICATIONS

This invention is a multiple biobags (single-use bags) liquid mixing system. The method of mixing utilizes the harmonic frequency of the fluids in the bags. Other single-use bag mixers now marketed use a single rocker platform which rocks one bag, rocking the entire bag and requires the bag to be clamped to the mixing platform. WAVE Biotech has a commercially available single bag rocker mixer.

### STATEMENT REGARDING FEDERALLY SPONSORED

### RESEARCH OR DEVELOPEMENTS

No federal assistance used.

### BACKGROUND OF THE INVENTION

The undulating (harmonic) liquid mixing device will target the Pharmaceutical and Biotechnology industries but is not limited to these industries. The single-use sterile bags have be used for mixing and storing liquids were introduced to the market in 1986. The initial bags were used to replace glass carboys to store and ship buffers and media. The advantage of the single-use bags was the elimination of cross contamination, improve the sterile environment, reduce clean-up and shorten validation time required with glass or stainless steel vessels. The first bag mixing systems used re-circulated of the bag fluids by using a Peristaltic pump on a loop outside the bag. When bags started to be used in the 1990's as single-use bioreactor for the growth of cell culture, rocker platforms were used for mixing and surface aeration of the growing cells. The single-use bioreactor rocker bags ranged from 10 liters to 500 liters clamped on a dedicated rocker platform. The rocker platforms rocked the entire bag and required to clamp the bags to the rocking platform. The Undulating multiple bags mixing systems does not require the bags to be clamped down. The undulating multiple bags mixer is very energy efficient since only the end of the bag is moved to reach the peak harmonic mixing point. The undulating mixing system can mix liquids gently or be used as a bioreactor for mammalian cell culture, plant or insect culture. The long rectangular clear film bags lay flat on the rack platforms which allow UV or white lights to be placed over each bag when light is required for cell growth. To maintain the sterility of bags used as bioreactor bags, the bags are a closed system. All fluids pumped into the bags are pumped though a 0.1 or 0.2 micron filter, air vents have 0.2 micron filter, particularly important if disposable aerators are used with the bioreactor bag. The mixing bags are environmental friendly for disposable by incineration.

### BRIEF SUMMARY OF THE INVENTION

The multiple bag single-use bag mixing device allow for mixing multiple bags simultaneously. The multiple bags ranging from 10 to 50+liters can be configured for one to five bags on single racks and ten bags when two bags are positioned on each rack level. The variable speed drive lifts all the bag ends Continuously or intermittently at or near the harmonic frequency of the liquid to maintain the degree of agitation required.

### BRIEF DESCRIPTION OF DRAWINGS

FIG. 1—drawing of the single-use bag end tilting assembly

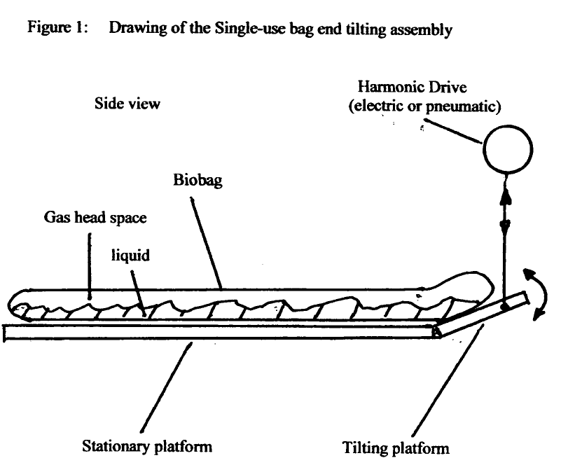

FIG. 2—drawing of a 3 tiers, single bag per rack platform, 30 liter harmonic bag mixer

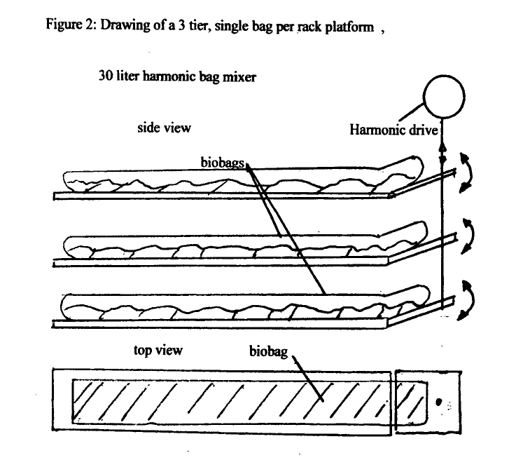

### DETAILED DESCRIPTION OF THE INVENTION

The invention of the multiple biobag (single-use bag) liquid mixing system utilizes the harmonic frequency of the fluids in the bags to provide mixing. The harmonic frequency is determined by the viscosity of the fluid and bag dimensions. The degree of mixing intensity is provided by a variable speed drive moving the one end of all the bags simultaneously. The multiple bags are laid on a stationary rack, typically five to six racks high one bag per rack. Were larger numbers of bags to be mixed are required a double rack for two adjacent bags can be configured. The number of bags that can be mixed simultaneously in a single rack is typically one to six bags however more level would be possible. Using two bags per rack level would increase the number of bags mixed simultaneously to twelve bags. Higher racks could allow for additional bags to be mixed. The stationary rack has a smooth surface to rest the bags which can be provided with sides to retain the liquid if the bag breaks. The rack platform is sized to hold the bag which range from 10 liters to 50+liters. Thus the total fluid typically mixed on a double rack of 50 liter bags is 600 liters. The bags have a rectangular sharp to enhance the harmonic mixing action. A moveable section of the rack platform usually one fifth of the total length will move continuously up and down to produce the harmonic mixing in the bag. A timer or interlock with the pumps feeding the bags can be provided were the mixing is not required to be continuous. In certain mixing applications a UV or white light may be required to enhance cell growth in the bags. This light source can be positioned over the bags requiring exposure. The bags film is translucent so the light can pass through the bags. In processes were the DO, pH, temperature or CO2 are required to be monitored single-use sensors can be included inside the bags to monitor the bag fluids. The bags do not require to be clamped to the racks since only on end of the bag is lifted for a 30 liter bag the harmonic rate is 7 to 8 cycles per minute. The rate of lifting will vary dependent of the shape of the bag, volume of fluids and viscosity of the fluids. The rate of lifting the end of the bag is low so very little abrasion is possible on the bag film however if long continuous mixing is required a thin flexible protective sheet is provided to avoid and wear on the bag film. A single-use aerator can be included inside the bags under the liquid the entire bag is gamma sterilized to assure sterility. The aerator must be made of CLASS VI material in sterile biological process, typically single-use stainless steel, plastic or ceramic aerators are used for these applications. All fluids pumped into the bags are isolated to assure sterility by a 0.1 or 0.2 micron filters. All vents to release excess gases from the bag have a 0.1 or 0.2 micron filter to assure accuracy. The bags used for mixing can be non sterile if the application allows however the bags used for most Pharmaceutical and Biotech applications will be closed system and gamma sterilized, with the film, tubing, connector, filters, aerator made of CLASS VI materials. The racks can be stainless steel or plastic this is determined by the application.

1. The continuous or intermittent mixing of fluids in single-use (disposable) bag by lifting one end of the bag at a rate constant with the harmonic frequency determined by the viscosity of the fluid and shape of the bag.

2. This method of mixing allows for an energy efficient mixing of multiple sterile single-use bags positioned on stationary rack with a common variable speed mixer drive.

3. The clear film single-use mixing bags are positioned on the multiple racks (no clamps required) allows exposing each bag to UV or white light source positioned over each bag when required.
